(19) United States
(12) Patent Application Publication
(10) Pub. No.: US 2026/0290109 A1
(43) Pub. Date: Sep. 24, 2026

(54) Smart Cigar Vending Machine with Built-in Cutter, Match Dispenser, and Advanced Climate Control

(71) Applicant: John Paul Yanes, Miami, FL (US)

(72) Inventor: John Paul Yanes, Miami, FL (US)

(21) Appl. No.: 19/087,592

(22) Filed: Mar. 24, 2025

(51) Int. Cl. G07F 11/24; A24F 25/00; G07F 11/00; G07F 11/72; G07F 17/00

(52) U.S. Cl. CPC G07F 11/24; A24F 25/00; G07F 11/005; G07F 11/72; G07F 17/0014

(57) ABSTRACT

A vending machine for cigars and similar smoking products is provided, comprising a main housing with an interior cavity, a transparent display portion, and a plurality of inclined shelving and dispensing units arranged in stable stacks. Each stack has a motorized dispensing cylinder that controllably delivers cigars to a drop tray for user retrieval. The vending machine includes a climate control system to maintain optimal humidity and temperature, preserving cigar freshness. Additional features include a touchscreen interface, age-verification system, manual cigar cutter with removable bin, match dispensing system, cashless payment system, and remote monitoring via a mobile or web-based platform for inventory, environmental, and operational status. Modular design, battery backup, LED accent lighting, customizable branding, and tamper-proof security enhance operational reliability, ease of maintenance, and visual appeal, providing a secure, user-friendly, and commercially attractive cigar vending solution.

### TECHNICAL DESCRIPTION OF INVENTION

The present invention relates to an advanced cigar vending machine designed to provide a seamless and high-end purchasing experience while maintaining optimal cigar preservation. The machine integrates a non-jamming rotary cylinder dispensing mechanism, a climate control system, and a user-friendly digital interface to ensure smooth operation and premium product quality.

The dispensing system features a rotary cylinder mechanism engineered to prevent jams and ensure the gentle handling of cigars. Each cigar is stored within a compartment that rotates in response to a user's selection, aligning the dispensing slot with the corresponding cigar. A controlled release mechanism allows the cigar to be deposited into a cushioned drop tray, which minimizes impact and protects the integrity of the product. This system ensures precise, single-unit dispensing and is designed to prevent multiple cigars from being released simultaneously.

To maintain the cigars in ideal storage conditions, the machine incorporates a climate control system that regulates both humidity and temperature. A built-in humidification unit maintains relative humidity between 65% and 72%, while a temperature control system keeps the internal temperature within a range of 65° F. to 72° F. Embedded sensors continuously monitor environmental conditions, providing real-time adjustments to ensure optimal preservation. If any deviation occurs, the system triggers alerts via an integrated remote monitoring platform, allowing operators to address issues proactively.

The vending machine includes an interactive touchscreen interface that allows users to browse available cigars, view detailed product descriptions, and complete transactions seamlessly. The touchscreen is programmed to support age verification technology, which requires users to scan a government-issued ID or use biometric authentication such as fingerprint or facial recognition before purchasing.

The machine also integrates a manual cigar cutter and a match dispenser to enhance the user experience. The cutter, positioned adjacent to the dispensing tray, offers straight, V-cut, and perforator options, enabling customers to prepare their cigars immediately. A coil-based match dispensing unit provides branded matchboxes in synchronization with each cigar purchase, ensuring users have the necessary accessories for an enhanced smoking experience.

For security and convenience, the vending machine supports a cashless payment system, including credit/debit card transactions and mobile payment options such as Apple Pay and Google Wallet. The system is secured with encrypted data processing protocols to protect user information and transaction details.

The machine is designed with a modular construction, allowing for easy maintenance and component replacement. Essential components such as the humidification unit, match storage compartment, and dispensing cylinders are removable and replaceable without requiring extensive downtime. Additionally, a battery backup system ensures continued climate control operation during power outages, preserving cigar quality.

With its luxury aesthetic, durable materials, and smart connectivity, this cigar vending machine provides a sophisticated, automated retail solution that enhances both operational efficiency and consumer experience in upscale environments.

### BACKGROUND OF INVENTION

The sale of premium cigars is traditionally confined to specialized retailers such as cigar lounges, tobacco shops, and select high-end establishments. While these locations provide an immersive purchasing experience, they are limited by operating hours, staffing costs, and geographic constraints, reducing accessibility for consumers who seek premium cigars outside of standard retail environments. Additionally, conventional vending machines have been used for selling tobacco products, but existing designs fail to address the unique storage and preservation requirements of cigars, which are highly sensitive to environmental conditions such as humidity and temperature fluctuations.

Traditional vending machines used for dispensing tobacco products primarily focus on cigarettes and lack the necessary climate control systems required to maintain the freshness of cigars. Cigars require stable humidity levels between 65% and 72% and a consistent temperature between 65° F. and 72° F. to prevent them from drying out or becoming overly moist. Without proper environmental control, cigars quickly lose their flavor, aroma, and overall quality, making traditional vending solutions unsuitable for their storage and sale. While some vending machines incorporate basic humidification features, they often lack the precise control, real-time environmental monitoring, and automated adjustments necessary for long-term cigar preservation.

Another major limitation of existing cigar vending solutions is the lack of integrated accessories and tools necessary for an optimal user experience. When purchasing a cigar, customers often require a cutter and matches or a lighter to enjoy their purchase immediately. Traditional vending machines do not accommodate these essential accessories, forcing customers to seek additional tools separately, which diminishes convenience and practicality.

Additionally, compliance with age restriction regulations presents significant challenges for vending machines that sell cigars and other regulated products. Many existing machines rely on manual ID verification or simple card scanning methods, which are susceptible to misuse and often require human oversight. These systems lack the technological rigor needed to ensure consistent and verifiable compliance with legal age requirements. With advancements in biometric authentication, optical document scanning, and AI-powered liveness detection, there is a growing demand for vending machines to incorporate secure, fully automated age verification solutions that eliminate the need for external supervision while maintaining regulatory integrity.

In terms of usability and reliability, traditional vending machines also suffer from frequent jamming and mechanical failures, especially when handling delicate products such as cigars. Many existing machines use gravity-fed or spiral coil mechanisms, which are prone to misalignment, crushing, or multi-unit dispensing errors. These issues not only compromise product integrity but also lead to operational inefficiencies, maintenance burdens, and poor user experiences.

The present invention addresses these challenges by introducing a smart cigar vending machine that incorporates a precision rotary dispensing mechanism, advanced climate control, integrated cigar accessories, biometric age verification, and smart inventory tracking. This vending machine is designed to enhance accessibility, preserve product quality, and streamline transactions while maintaining a luxurious and sophisticated appeal suitable for upscale environments such as casinos, lounges, night clubs, golf clubs, hotels, and high-end bars. By merging technological innovation with premium product vending, this invention fills a critical gap in the market and establishes a new standard for automated cigar sales.

### SUMMARY OF INVENTION

The present invention introduces a smart cigar vending machine that elevates automated cigar retailing through the seamless integration of climate-controlled storage, precision dispensing, and age-restricted sales. Distinguishing features include an embedded cigar preparation area with a multi-function cutter and a match dispenser, offering customers everything they need to enjoy a premium cigar on the spot. The system is designed to uphold both product integrity and regulatory compliance while delivering a luxury-level user experience in upscale venues.

At the heart of the vending system is a rotary dispensing module that eliminates jamming risks while ensuring gentle handling of each cigar. The mechanism stores cigars in isolated compartments and rotates to present the selected item above a soft-landing tray. This precise, compartmentalized design not only safeguards the product's physical condition but also prevents the release of more than one cigar per transaction, addressing a common flaw in traditional vending designs.

To ensure cigars remain in optimal condition throughout storage and dispensing, the vending machine employs a robust climate control system designed for reliability and long-term performance. This system dynamically maintains internal humidity between 65% and 72% and temperature within the range of 65° F. to 72° F., using intelligent sensor feedback loops that continuously adjust environmental settings as needed. Unlike basic humidors or passive systems, this fully integrated setup operates autonomously and is paired with a remote monitoring platform, allowing operators to receive proactive alerts in the event of environmental deviations. This approach not only preserves the flavor and structure of premium cigars but also reduces the need for manual oversight and intervention.

A responsive, interactive touchscreen guides the customer through the cigar selection and purchase process, displaying detailed product information and tasting notes. To enforce legal age restrictions, the system requires digital identity verification, including government-issued ID scanning and optional biometric verification such as fingerprint or facial recognition. These layers of protection help ensure compliance with tobacco sales laws without requiring onsite staff.

User convenience is further enhanced by integrated accessories, including a precision cigar cutter offering three distinct cutting styles and a synchronized match dispenser. These features are built into the machine's exterior for immediate post-purchase use, streamlining the entire cigar-smoking ritual from acquisition to enjoyment. Their inclusion sets the machine apart from conventional vending units that offer cigars without the necessary tools for immediate use.

Transactions are entirely cashless and secure, with the machine supporting EMV card readers and mobile wallet platforms such as Apple Pay and Google Wallet. The payment system is fortified by encrypted processing protocols that protect customer data, ensuring PCI compliance and minimizing the risk of transaction-related fraud.

The internal structure of the vending machine is modular, allowing for quick component replacements and minimal downtime during maintenance. Key serviceable parts, including the humidifier, dispensing units, and accessory compartments, are independently accessible and easily swappable. A built-in battery backup ensures that climate control functions continue uninterrupted during power loss, protecting the stored inventory until power is restored.

Visually, the machine is designed to blend into high-end environments through its use of sleek materials, ambient lighting, and a modern form factor. Paired with smart connectivity for remote monitoring and inventory management, the unit functions as both a sales device and a branding asset. Its presence enhances the atmosphere of luxury spaces such as cigar lounges, golf clubs, hotels, and nightlife venues while offering patrons a convenient, upscale purchasing experience.

### DESCRIPTION OF DRAWINGS

The accompanying drawings illustrate various views and components of the smart cigar vending machine, demonstrating its structural design, internal mechanisms, and functional elements. These figures provide a detailed representation of the machine's operation, showcasing the dispensing system, climate control features, user interface, and integrated accessory dispensers.

FIG. 1 provides a front perspective view of the cigar vending machine, highlighting its tall, sleek, and rectangular design suitable for upscale venues. The tempered glass display window is prominently featured, allowing customers to view available cigars. The touchscreen interface is positioned at the upper portion of the machine, enabling user interaction for product selection, age verification, and payment processing. The payment module, located below the touchscreen, supports both card transactions and mobile payments.

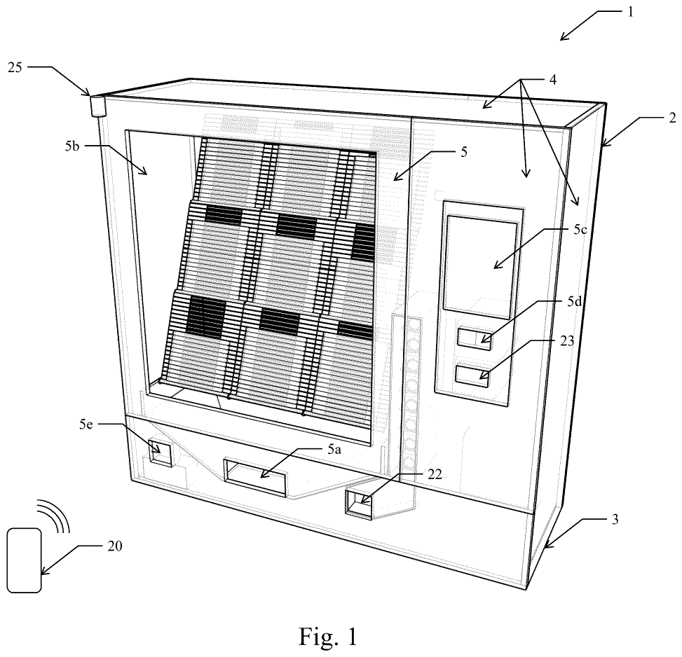

FIG. 2 illustrates a three-dimensional view of the vending machine, emphasizing its compact yet high-end design. The slanted shelving inside the glass display allows cigars to be easily viewed while being protected in a climate-controlled environment. The placement of essential components, including the cigar cutter and match dispenser, are strategically positioned to optimize usability and streamline the purchasing experience.

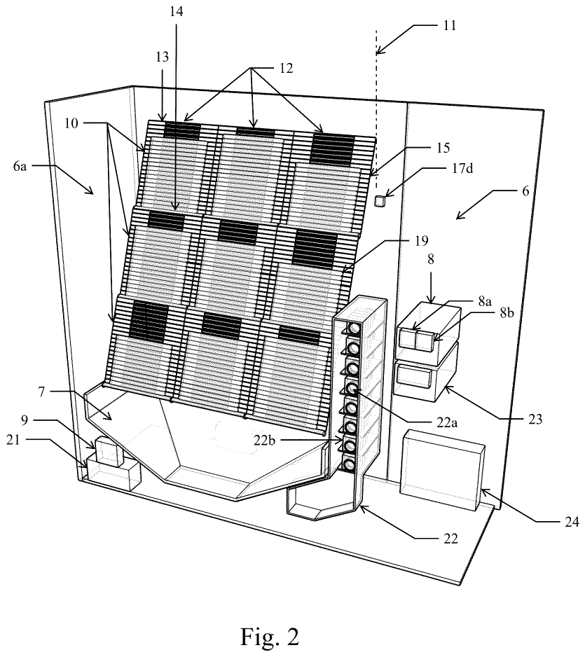

FIG. 3 illustrates the rotary cylinder dispensing mechanism that ensures smooth and controlled cigar release. The mechanism consists of a hollow cylinder with a plane subtraction that rotates on its own axis. In the initial position, the mechanism prevents the cigars from falling. When activated, it rotates to allow a single cigar to drop while preventing multiple cigars from dispensing at once. The rotation continues, resetting to its original position for the next operation. This ensures non-jamming and controlled dispensing, preventing cigar damage.

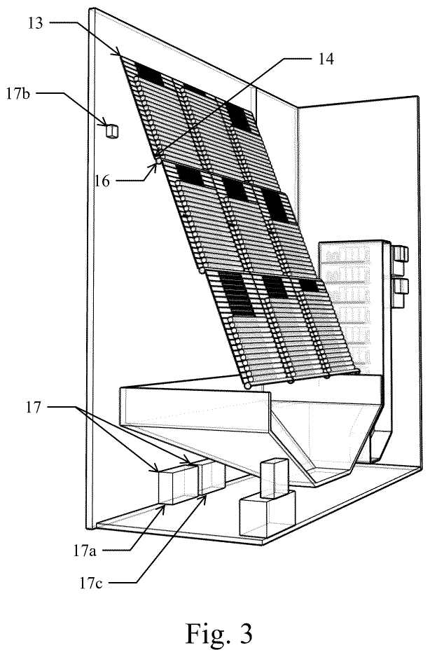

FIG. 4 depicts the integrated cigar cutting system, which includes three cutting options: straight cut, V-cut, and perforation. The perforator is designed to puncture a small hole in the cigar cap, allowing users to customize their smoking experience without removing the cap entirely. The cigar cutter is positioned adjacent to the dispensing tray for immediate use after purchase. This feature enhances user preference by providing multiple preparation options within the vending machine.

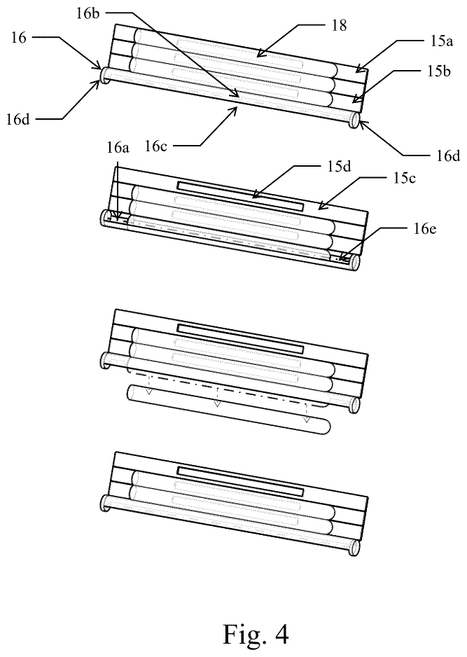

Collectively, these drawings provide a comprehensive visual representation of the smart cigar vending machine, illustrating its aesthetic appeal, innovative dispensing technology, climate control capabilities, and user-friendly interface.

### DETAILED DESCRIPTION OF INVENTION

The present invention relates to an advanced cigar vending machine that integrates automated dispensing technology with climate control, security, and user convenience. This vending machine is designed to maintain premium cigars in optimal storage conditions while offering a seamless purchasing experience through a digital interface with secure payment and age verification capabilities. The machine is intended for upscale environments such as cigar lounges, golf clubs, luxury hotels, and high-end bars, where customers expect both quality and convenience in their purchasing experience.

The vending machine features a structurally robust yet aesthetically refined design, constructed with a combination of high-gloss metal, tempered glass, and wood-finished accents, ensuring both durability and a premium aesthetic appeal. The wood finish enhances the luxurious presentation, making the machine suitable for upscale venues such as casinos, hotels, and golf clubs. The machine's front panel includes a transparent display window, allowing customers to view the available cigars while maintaining the integrity of the controlled storage environment. A touchscreen interface is positioned at the upper portion of the machine, providing a user-friendly platform for browsing cigar options, viewing detailed product descriptions, and selecting purchases. The touchscreen also integrates an age verification system, ensuring compliance with legal tobacco sales regulations through document scanning or biometric authentication.

The vending machine incorporates a wood-finished exterior paneling, blending modern technology with classic luxury. This finish not only enhances visual appeal but also aligns with traditional cigar lounge aesthetics, complementing fine wood furniture and humidor cabinets commonly found in premium establishments.

At the core of the invention is a specialized dispensing mechanism utilizing a non-jamming rotary cylinder system. This system is designed to prevent mechanical failures and misalignment issues commonly found in traditional vending machines. The rotary cylinder operates by aligning a dispensing slot with the selected cigar, ensuring a smooth and controlled release into a cushioned drop tray. This mechanism is particularly advantageous for cigars, as it minimizes the risk of damage that could result from improper handling. The cigars are stored within individual compartments that prevent contact with adjacent units, preserving their integrity until they are dispensed. The non-jamming feature ensures that the machine can reliably operate for extended periods without requiring frequent maintenance or manual intervention.

To preserve the integrity of stored cigars, the vending machine is equipped with a high-performance climate control system tailored for the unique preservation needs of premium tobacco products. The internal environment is actively maintained within a humidity range of 65% to 72% and a temperature range of 65° F. to 72° F., creating stable storage conditions that prevent flavor degradation or structural damage. Digital sensors embedded throughout the chamber provide continuous environmental readings, and the system dynamically adjusts humidification and cooling elements in response to real-time data. A remote alert function is built into the monitoring platform, enabling operators to receive immediate notifications when environmental readings drift outside the optimal range, allowing for timely intervention and uninterrupted product quality.

In addition to dispensing cigars, the vending machine is equipped with an integrated cigar cutter and match dispenser, enhancing the user experience by providing essential accessories. The cutter, located adjacent to the drop tray, offers straight, V-cut, and perforator options, allowing customers to prepare their cigars immediately after purchase. The match dispenser, which operates through a coil-based delivery system, synchronizes with the cigar dispensing process to provide a branded matchbox with each transaction. This feature eliminates the need for customers to seek additional accessories separately, further streamlining the purchasing process.

The vending machine includes a dispense bin located beneath the integrated cigar cutter. This bin is designed to catch the cut portions of cigars, ensuring a clean and organized dispensing area. The bin is securely enclosed within the machine and is only accessible by authorized personnel, preventing users from interacting with or removing the collected trimmings. The bin is removable by the vendor during routine restocking and maintenance, allowing for efficient disposal of cigar trimmings while maintaining a sanitary and unobstructed dispensing area. This feature enhances the usability of the machine by reducing waste accumulation, preventing user tampering, and ensuring continued operational efficiency.

Security and regulatory compliance are key aspects of the invention. The vending machine includes an advanced age verification system that ensures only eligible customers can make purchases. This system utilizes a combination of ID scanning and biometric authentication, allowing users to verify their age through fingerprint or facial recognition technology. This approach not only enhances security but also minimizes the risk of fraudulent transactions. The machine's payment system is entirely cashless, supporting credit and debit card transactions as well as mobile payment options such as Apple Pay and Google Wallet. Secure encryption protocols are implemented to protect transaction data, ensuring compliance with financial security standards.

The vending machine is designed with operational efficiency in mind, featuring a modular construction that facilitates easy maintenance and servicing. Essential components, including the humidification unit, match storage compartment, and dispensing cylinders, are housed within accessible compartments that can be replaced or serviced without requiring extensive downtime. This modular approach enhances the longevity of the machine while reducing maintenance costs. Additionally, a built-in battery backup system ensures that critical functions, such as climate control, remain operational during power outages. This feature is particularly important in locations where power disruptions could otherwise compromise the quality of stored cigars.

To provide seamless remote management, the vending machine is equipped with a smart connectivity system that allows operators to monitor its performance in real time. The system is integrated with a dedicated mobile application or web-based platform that provides inventory tracking, sales analytics, and maintenance alerts. Operators can remotely access data on cigar stock levels, transaction history, and machine status, allowing for proactive restocking and troubleshooting. The system can also send automated notifications for low inventory levels, temperature fluctuations, or mechanical issues, ensuring that the vending machine remains fully operational with minimal manual oversight.

The vending machine is designed to accommodate a range of cigar sizes and brands, with adjustable compartments that allow for customization based on inventory needs. Each compartment is configured to prevent unnecessary movement of the cigars, further ensuring that they remain undamaged during storage. The glass display panel, while offering visibility, is sealed to maintain internal climate conditions, preventing external air exposure that could degrade cigar quality. The design prioritizes both functionality and elegance, ensuring that the vending machine seamlessly integrates into premium hospitality and entertainment venues.

The invention also includes security measures to prevent unauthorized access and tampering. The vending machine is equipped with tamper-proof locks and reinforced structural components to protect its internal mechanisms. Additionally, an integrated surveillance camera can be included to provide real-time monitoring, deterring potential theft or vandalism. The security features ensure that the machine remains a reliable and secure point-of-sale solution for premium cigars in high-traffic locations.

Overall, the smart cigar vending machine represents a significant advancement in automated retail solutions for luxury cigars. By combining precision dispensing, climate-controlled storage, digital payment integration, age verification, and remote monitoring, the invention provides a fully automated and secure means of distributing high-quality cigars. This innovative solution addresses the limitations of traditional vending systems while enhancing accessibility and customer experience in upscale venues. The machine's sophisticated design, coupled with its advanced functionality, makes it an ideal choice for establishments looking to offer a premium and convenient cigar purchasing experience.

What is claimed is:

1-15. (canceled)

16. A vending machine for cigars and other similar smoking products, collectively referred to herein as cigars, the vending machine comprises:
a main housing with a base and a plurality of surfaces that collectively define an interior cavity, one of the plurality of surfaces is a front surface, the front surface has a dispensing aperture that provides access to a drop tray disposed within the interior cavity, a transparent display panel configured to exhibit a display portion of the interior cavity, a touchscreen interface configured to receive user input, a scanner port operatively connected to an age-verification system disposed within the interior cavity, and a cigar cutter aperture that provides access to a cigar cutter disposed within the interior cavity;
a plurality of shelving and dispensing units inclined relative to a vertical axis and disposed within the display portion of the interior cavity of the main housing above the drop tray, each shelving and dispensing unit is divided into a plurality of columnar segments arranged side by side, each columnar segment has a stack of compartments that extends between an upper end and a lower end of the columnar segment, and a motorized dispensing cylinder disposed at the lower end adjacent to the lowest compartment of the stack of compartments; and
a climate control system disposed within the main housing;
wherein each compartment of the stack of compartments, except for the lowest compartment, is configured to shelve and display a cigar in a manner that enables the cigar to physically support a cigar in the compartment immediately above and be physically supported by a cigar in the compartment immediately below, the lowest compartment is configured to shelve and display a cigar in manner that enables the cigar to physically support a cigar in the compartment immediately above and be physically supported by the motorized dispensing cylinder below, thereby forming a stable stack of cigars;
wherein the motorized dispensing cylinder controllably delivers cigars from the stack of cigars to the drop tray below and is configured to reduce or eliminate the risk of blockage of cigars during dispensing;
wherein the drop tray is configured to collect cigars delivered thereto and to direct the collected cigars toward the dispensing aperture of the front surface of the main housing for retrieval; and
wherein the climate control system is configured to regulate the environmental conditions within the display portion of the interior cavity of the main housing to maintain the quality of the cigars shelved and displayed therein.

17. The vending machine for cigars of claim 16, wherein the climate control system has a humidity control system with at least one humidity sensor and a temperature control system with at least one temperature sensor, which are configured to regulate the humidity and temperature, respectively, of the display portion of the interior cavity of the main housing.

18. The vending machine for cigars of claim 17, wherein the climate control system maintains the display portion of the interior cavity of the main housing at approximately 70 percent relative humidity and approximately degrees Fahrenheit to preserve the freshness of the cigars shelved and displayed therein.

19. The vending machine for cigars of claim 18, wherein each compartment has a shelving wall configured to shelve a cigar, the shelving wall has at least one opening that partially exposes the area of the cigar that is in contact with the shelving wall to the environmental conditions within the display portion of the interior cavity of the main housing, thereby aiding in preserving the freshness of the cigar.

20. The vending machine for cigars of claim 16, wherein the motorized dispensing cylinder has a rotary axis oriented substantially horizontally and a side wall that extends along the rotary axis between two opposing ends of the motorized dispensing cylinder, the side wall and the two opposing ends collectively define a cylindrical receptacle that is configured to receive a cigar through an elongated aperture formed in the side wall, the elongated aperture extends along the rotary axis for a length equal to or greater than the length of the cigar.

21. The vending machine for cigars of claim 20, wherein the side wall of the motorized dispensing cylinder aligns with the cigar in the lowest compartment of the stack of compartments above whereas the elongated aperture is oriented downward toward the drop tray below, the cigar is delivered to the cylindrical receptacle by gravity upon aligning the elongated aperture with the cigar through controlled rotation of the motorized dispensing cylinder about the rotary axis, thereby causing each of the remaining cigars of the stack of cigars to transfer controllably into the compartment immediately below, the cigar in the cylindrical receptacle is delivered to the drop tray by gravity upon further controlled rotation of the motorized dispensing cylinder about the rotary axis, which reorients the elongated aperture downward toward the drop tray and realigns the side wall with the subsequent cigar in the lowest compartment, thereby maintaining the stability of the stack of cigars.

22. The vending machine for cigars of claim 16, wherein the vending machine has a remote monitoring system connected to a mobile application or web-based platform that provides real-time information on cigar inventory levels, environmental conditions within the display portion of the interior cavity of the main housing, vending machine performance, maintenance notifications, sales analytics, or any combination thereof.

23. The vending machine for cigars of claim 16, wherein the age-verification system has an optical scanner for government-issued identification document validation, a biometric scanner for fingerprint or facial recognition authentication, or both.

24. The vending machine for cigars of claim 16, wherein the cigar cutter has the capability of providing a straight cut, a V-cut and a perforation, the vending machine has a removable dispense bin for discarded cigar trimmings, the removable dispense bin is configured to be easily disposed by authorized personnel during servicing and restocking of the vending machine.

25. The vending machine for cigars of claim 16, wherein the vending machine has a match dispensing system with a coil-based match dispenser that synchronizes with each cigar transaction to provide a branded matchbox.

26. The vending machine for cigars of claim 16, wherein the vending machine has a cashless payment system that is secured with encrypted data processing protocols.

27. The vending machine for cigars of claim 16, wherein the transparent display panel of the front surface of the main housing is made of a tempered glass material, and at least one of the plurality of remaining surfaces is a high-gloss metallic wood-finished panel.

28. The vending machine for cigars of claim 16, wherein the motorized dispensing cylinders and the humidity control system have a modular design that allows rapid maintenance or replacement with minimal vending machine downtime.

29. The vending machine for cigars of claim 16, wherein the vending machine has a battery backup system configured to power the vending machine during power outages, thereby preventing unintended operational interruptions.

30. The vending machine for cigars of claim 16, wherein the vending machine has tamper-proof security features to prevent unauthorized access to the vending machine and ensure operational integrity, the tamper-proof security features include, but are not limited to, a reinforced material for the main housing, digital access control and a surveillance system.

31. The vending machine for cigars of claim 16, wherein the touchscreen interface displays cigar related information such as cigar origin, flavor and strength to enhance the purchasing experience.

32. The vending machine for cigars of claim 16, wherein the vending machine has light-emitting diode accent lighting and customizable branding capabilities to enable digital advertising and promotional displays.

33. The vending machine for cigars of claim 16, wherein the drop tray is cushioned to minimize or eliminate the risk of damaging the cigars during dispensing.

34. The vending machine for cigars of claim 16, wherein the cigar cutter is manually operated.
